(19) United States
(12) Patent Application Publication
(10) Pub. No.: US 2024/0386009 A1
(43) Pub. Date: Nov. 21, 2024

(54) SYSTEMS, APPARATUSES, METHODS, AND COMPUTER PROGRAM PRODUCTS FOR BACKFILLING OF REAL-TIME DATA

(71) Applicant: HONEYWELL INTERNATIONAL INC., Charlotte, NC (US)

(72) Inventor: Bhabesh Chandra ACHARYA, Bangalore (IN)

(21) Appl. No.: 18/320,548

(22) Filed: May 19, 2023

(51) Int. Cl. G06F 16/23

(52) U.S. Cl. CPC G06F 16/2365

(57) ABSTRACT

Systems, apparatuses, methods, and computer program products for backfilling sensor data are provided. For example, a method provided herein may include receiving sensor data from a sensor during a first time period. In some embodiments, the method may include generating improved sensor data. In some embodiments, the method may include routing the sensor data to a first database and the improved sensor data to a second database. In some embodiments, the method may include receiving second sensor metadata during a second time period. In some embodiments, the method may include retrieving the sensor data from the first database. In some embodiments, the method may include generating updated improved sensor data. In some embodiments, the method may include routing the updated improved sensor data to the second database.

### TECHNOLOGICAL FIELD

Embodiments of the present disclosure relate generally to backfilling of sensor data, such as sensor data received in real-time.

### BACKGROUND

Applicant has identified many technical challenges and difficulties associated with backfilling of sensor data, such as sensor data received in real-time. Through applied effort, ingenuity, and innovation, Applicant has solved problems related to backfilling of sensor data, such as sensor data received in real-time, by developing solutions embodied in the present disclosure, which are described in detail below.

### BRIEF SUMMARY

Various embodiments described herein relate to backfilling of sensor data, such as sensor data received in real-time.

In accordance with one aspect of the disclosure, a computer-implemented method is provided. In some embodiments, the computer-implemented method may include receiving sensor data from a sensor during a first time period. In some embodiments, the computer-implemented method may include generating improved sensor data. In some embodiments, generating the improved sensor data comprises processing the sensor data in a first sensor data processing unit based at least in part on first sensor metadata. In some embodiments, the computer-implemented method may include routing the sensor data to a first database and the improved sensor data to a second database. In some embodiments, the computer-implemented method may include receiving second sensor metadata during a second time period. In some embodiments, the computer-implemented method may include retrieving the sensor data from the first database. In some embodiments, the computer-implemented method may include generating updated improved sensor data. In some embodiments, generating the updated improved sensor data comprises processing the sensor data in a second sensor data processing unit based at least in part on the second sensor metadata. In some embodiments, the computer-implemented method may include routing the updated improved sensor data to the second database.

In some embodiments, the improved sensor data is routed to a first container in the second database.

In some embodiments, the updated improved sensor data is routed to a second container in the second database.

In some embodiments, the computer-implemented method may include generating an ingestion specification.

In some embodiments, the ingestion specification is configured to instruct the second database to overwrite at least a portion of the improved sensor data in the first container with at least a portion of the updated improved sensor data in the second container.

In some embodiments, the computer-implemented method may include transmitting the ingestion specification to the second database.

In some embodiments, the first sensor data processing unit comprises at least one of first ontology circuitry, first normalization circuitry, or first interpolation circuitry and the second sensor data processing unit comprises at least one of second ontology circuitry, second normalization circuitry, or second interpolation circuitry.

In some embodiments, the first ontology circuitry is configured to associate the first sensor metadata with the sensor data.

In some embodiments, the second ontology circuitry is configured to associate the second sensor metadata with the sensor data.

In some embodiments, the second database is a time series database.

In some embodiments, generating the improved sensor data occurs in real-time.

In some embodiments, the computer-implemented method may include receiving second sensor data from the sensor during the second time period.

In some embodiments, the computer-implemented method may include generating second improved sensor data.

In some embodiments, generating the second improved sensor data comprises processing the second sensor data in the first sensor data processing unit based at least in part on the second sensor metadata.

In accordance with another aspect of the disclosure, an apparatus is provided. In some embodiments, the apparatus may include at least one processor and at least one memory coupled to the at least one processor. In some embodiments, the at least one processor is configured to receive sensor data from a sensor during a first time period. In some embodiments, the at least one processor is configured to generate improved sensor data. In some embodiments, generating the improved sensor data comprises processing the sensor data in a first sensor data processing unit based at least in part on first sensor metadata. In some embodiments, the at least one processor is configured to route the sensor data to a first database and the improved sensor data to a second database. In some embodiments, the at least one processor is configured to receive second sensor metadata during a second time period. In some embodiments, the at least one processor is configured to retrieve the sensor data from the first database. In some embodiments, the at least one processor is configured to generate updated improved sensor data. In some embodiments, generating the updated improved sensor data comprises processing the sensor data in a second sensor data processing unit based at least in part on the second sensor metadata. In some embodiments, the at least one processor is configured to route the updated improved sensor data to the second database.

In some embodiments, the improved sensor data is routed to a first container in the second database.

In some embodiments, the updated improved sensor data is routed to a second container in the second database.

In some embodiments, the at least one processor is configured to generate an ingestion specification.

In some embodiments, the ingestion specification is configured to instruct the second database to overwrite at least a portion of the improved sensor data in the first container with at least a portion of the updated improved sensor data in the second container.

In some embodiments, the at least one processor is configured to transmit the ingestion specification to the second database.

In some embodiments, the first sensor data processing unit comprises at least one of first ontology circuitry, first normalization circuitry, or first interpolation circuitry and the second sensor data processing unit comprises at least one of second ontology circuitry, second normalization circuitry, or second interpolation circuitry.

In some embodiments, the first ontology circuitry is configured to associate the first sensor metadata with the sensor data.

In some embodiments, the second ontology circuitry is configured to associate the second sensor metadata with the sensor data.

In some embodiments, the second database is a time series database.

In some embodiments, generating the improved sensor data occurs in real-time.

In some embodiments, the at least one processor is configured to receive second sensor data from the sensor during the second time period.

In some embodiments, the at least one processor is configured to generate second improved sensor data.

In some embodiments, generating the second improved sensor data comprises processing the second sensor data in the first sensor data processing unit based at least in part on the second sensor metadata.

In accordance with another aspect of the disclosure, a non-transitory computer-readable storage medium is provided. In some embodiments, the non-transitory computer-readable storage medium comprises computer program code for execution by one or more processors of a device. In some embodiments, the computer program code is configured to, when executed by the one or more processors, cause the device to receive sensor data from a sensor during a first time period. In some embodiments, the computer program code is configured to, when executed by the one or more processors, cause the device to generate improved sensor data. In some embodiments, generating the improved sensor data comprises processing the sensor data in a first sensor data processing unit based at least in part on first sensor metadata. In some embodiments, the computer program code is configured to, when executed by the one or more processors, cause the device to route the sensor data to a first database and the improved sensor data to a second database. In some embodiments, the computer program code is configured to, when executed by the one or more processors, cause the device to receive second sensor metadata during a second time period. In some embodiments, the computer program code is configured to, when executed by the one or more processors, cause the device to retrieve the sensor data from the first database. In some embodiments, the computer program code is configured to, when executed by the one or more processors, cause the device to generate updated improved sensor data. In some embodiments, generating the updated improved sensor data comprises processing the sensor data in a second sensor data processing unit based at least in part on the second sensor metadata. In some embodiments, the computer program code is configured to, when executed by the one or more processors, cause the device to route the updated improved sensor data to the second database. In some embodiments, the improved sensor data is routed to a first container in the second database.

In some embodiments, the updated improved sensor data is routed to a second container in the second database.

In some embodiments, the computer program code is configured to, when executed by the one or more processors, cause the device to generate an ingestion specification.

In some embodiments, the ingestion specification is configured to instruct the second database to overwrite at least a portion of the improved sensor data in the first container with at least a portion of the updated improved sensor data in the second container.

In some embodiments, the computer program code is configured to, when executed by the one or more processors, cause the device to transmit the ingestion specification to the second database.

In some embodiments, the first sensor data processing unit comprises at least one of first ontology circuitry, first normalization circuitry, or first interpolation circuitry and the second sensor data processing unit comprises at least one of second ontology circuitry, second normalization circuitry, or second interpolation circuitry.

In some embodiments, the first ontology circuitry is configured to associate the first sensor metadata with the sensor data.

In some embodiments, the second ontology circuitry is configured to associate the second sensor metadata with the sensor data.

In some embodiments, the second database is a time series database.

In some embodiments, generating the improved sensor data occurs in real-time.

In some embodiments, the computer program code is configured to, when executed by the one or more processors, cause the device to receive second sensor data from the sensor during the second time period.

In some embodiments, the computer program code is configured to, when executed by the one or more processors, cause the device to generate second improved sensor data.

In some embodiments, generating the second improved sensor data comprises processing the second sensor data in the first sensor data processing unit based at least in part on the second sensor metadata.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an exemplary block diagram of an environment in which embodiments of the present disclosure may operate;

FIG. 2 illustrates an exemplary block diagram of an example apparatus that may be specially configured in accordance with an example embodiment of the present disclosure;

FIG. 3 illustrates an exemplary architecture of an example apparatus for backfilling sensor data;

FIG. 4 illustrates an example database in accordance with one or more embodiments of the present disclosure;

FIG. 5 illustrates an example user interface associated with the example apparatus for backfilling sensor data in accordance with one or more embodiments of the present disclosure; and

FIG. 6 illustrates a flow chart of an example method in accordance with one or more embodiments of the present disclosure.

### DETAILED DESCRIPTION

Example embodiments will be described more fully hereinafter with reference to the accompanying drawings, in which some, but not all embodiments of disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

### Overview

Example embodiments disclosed herein address technical problems associated with backfilling sensor data, such as sensor data received in real-time. As would be understood by one skilled in the field to which this disclosure pertains, there are numerous example scenarios in which a user may backfill sensor data, such as sensor data received in real-time.

In many applications, it is necessary to process sensor data (e.g., such as raw sensor data received in real-time) to create improved sensor data for use in a variety of applications. For example, many applications (e.g., a cloud computing application) may be configured to receive sensor data from one or more sensors associated with one or more or assets. In some examples, many applications may be configured to perform processing on the sensor data to generate improved sensor data (e.g., ontology processing). In some examples, the processing performed on the sensor data may be based at least in part on sensor metadata associated with a sensor. However, in some examples, the sensor metadata may be updated after an application has already processed at least some of the sensor data. As a result, in some examples, sensor data that has already been processed may be inaccurate because the processing was not based at least in part on the updated sensor metadata.

Example solutions for processing sensor data to create improved sensor data include, for example, processing sensor data as the sensor data is received and transmitting the improved sensor data to storage for use in a variety of applications. However, such example solutions, do not include a mechanism for updating previously processed sensor data if the sensor metadata used to process the sensor data is updated. As such, in such example solutions, if the sensor metadata is updated, previously processed sensor data (e.g., the improved sensor data at the time the sensor metadata is updated) must be disregarded. Accordingly, there is a need for systems, apparatuses, computer program products, and methods that enable the backfilling of previously processed sensor data such that, even if the sensor metadata that the processing was based at least in part on is updated, the previously processed sensor data may still be used. Additionally, there is a need for such systems, apparatuses, computer program products, and methods to be configured to backfill the previously processed sensor data without impacting the processing of sensor data that an application is currently receiving (e.g., without introducing processing delays or latency into the processing of newly received sensor data).

Thus, to address these and/or other issues, example systems, apparatuses, computer program products, and/or methods are disclosed herein. For example, an embodiment in this disclosure, described in greater detail below, includes a computer-implemented method that includes receiving sensor data from a sensor during a first time period. In some embodiments, the computer-implemented method may include generating improved sensor data. In some embodiments, generating the improved sensor data comprises processing the sensor data in a first sensor data processing unit based at least in part on first sensor metadata. In some embodiments, the computer-implemented method may include routing the sensor data to a first database and the improved sensor data to a second database. In some embodiments, the computer-implemented method may include receiving second sensor metadata during a second time period. In some embodiments, the computer-implemented method may include retrieving the sensor data from the first database. In some embodiments, the computer-implemented method may include generating updated improved sensor data. In some embodiments, generating the updated improved sensor data includes processing the sensor data in a second sensor data processing unit based at least in part on the second sensor metadata. In some embodiments, the computer-implemented method may include routing the updated improved sensor data to the second database. Accordingly, embodiments disclosed herein enable for the backfilling of sensor data using the second sensor data processing unit while still enabling the processing of sensor data that the application is currently receiving by the first sensor data processing unit (e.g., without introducing processing delays or latency into the processing of newly received sensor data).

### Example Apparatuses and Systems

Embodiments of the present disclosure herein include systems, apparatuses, methods, and computer program products configured for backfilling sensor data, such as sensor data received in real-time. It should be readily appreciated that the embodiments of the apparatus, systems, methods, and computer program product described herein may be configured in various additional and alternative manners in addition to those expressly described herein.

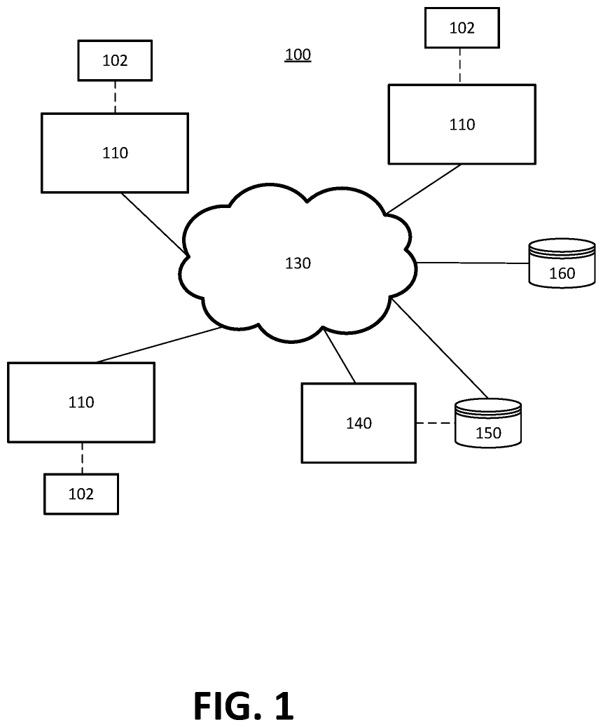

FIG. 1 illustrates an exemplary block diagram of an environment 100 in which embodiments of the present disclosure may operate. Specifically, FIG. 1 illustrates one or more sensors 110. In some embodiments, each of the one or more sensors 110 may be associated with an asset of one or more assets 102. In some embodiments, for example, the one or more assets 102 may be any type of facility associated with a user associated with the environment 100. For example, the one or more assets 102 may include at least one plant. In this regard, the one or more assets 102 may, for example, be a processing plant that receives and processes ingredients as inputs to create a final product, such as a hydrocarbon processing plant, a refinery plant, a drilling plant, a fracking plant, and/or the like. Additionally or alternatively, for example, the one or more assets 102 may include at least one building. In this regard, the one or more assets 102 may, for example, be an industrial building, office building, warehouse, building associated with a plant, and/or the like.

In some embodiments, each sensor of the one or more sensors 110 may be electronically and/or communicatively coupled to an associated asset of the one or more assets 102 and/or individual components of an associated asset of the one or more assets 102. In some embodiments, each sensor of the one or more sensors 110 may be located remotely, in proximity of, and/or within an associated asset of the one or more assets 102. In some embodiments, each sensor of the one or more sensors 110 is configured via hardware, software, firmware, and/or a combination thereof, to perform data intake of one or more types of data associated with one or more of the one or more assets 102 (e.g., capture data associated with one or more of the one or more assets 102). Additionally or alternatively still, in some embodiments, each sensor of the one or more sensors 110 is configured via hardware, software, firmware, and/or a combination thereof, to perform data reporting and/or other data output process(es) associated with monitoring or otherwise analyzing operations of one or more of the one or more assets 102 or specific component(s) thereof. In some embodiments, for example, each sensor of the one or more sensors 110 may comprise one or more of a heat sensor, a gas sensor, a temperature sensor, a humidity sensor, a particulate matter sensor, vibration sensor, an acceleration sensor, a virtual sensor and/or the like. In some embodiments, a virtual sensor may be a sensor configured to determine data based on data captured by one or more other sensors. For example, a virtual sensor may be configured to determine data (e.g., sensor data) based on data captured by a temperature sensor.

The network 130 may be embodied in any of a myriad of network configurations. In some embodiments, the network 130 may be a public network (e.g., the Internet). In some embodiments, the network 130 may be a private a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

In some embodiments, the environment 100 may include an apparatus for backfilling sensor data 140. The apparatus for backfilling sensor data 140 may be electronically and/or communicatively coupled to the one or more sensors 110, the one or more assets 102, a first database 150, and/or a second database 160. The apparatus for backfilling sensor data 140 may be located remotely, in proximity of, and/or within a particular sensor of the one or more sensors 110 and/or a particular asset the one or more assets 102. In some embodiments, the apparatus for backfilling sensor data 140 is configured via hardware, software, firmware, and/or a combination thereof, to perform data intake of one or more types of data associated with one or more of the one or more assets 102, the one or more sensors 110 (e.g., sensor data), the first database 150, and/or the second database 160. Additionally or alternatively, in some embodiments, the apparatus for backfilling sensor data 140 is configured via hardware, software, firmware, and/or a combination thereof, to generate and/or transmit command(s) that control, adjust, or otherwise impact operations of one or more of the one or more assets 102, the one or more sensors 110 the first database 150, and/or the second database 160. Additionally or alternatively still, in some embodiments, the apparatus for backfilling sensor data 140 is configured via hardware, software, firmware, and/or a combination thereof, to perform data reporting and/or other data output process(es) associated with monitoring or otherwise analyzing operations of one or more of the one or more assets 102, the one or more sensors 110, the first database 150, and/or the second database 160, for example for generating and/or outputting report(s) corresponding to the operations performed via the one or more assets 102 and/or the one or more sensors 110. For example, in various embodiments, the apparatus for backfilling sensor data 140 may be configured to execute and/or perform one or more operations and/or functions described herein.

The first database 150, and/or the second database 160 may be configured to receive, store, and/or transmit data, such as sensor data. In some embodiments, the sensor data may be received from the one or more assets 102, the one or more sensors 110, the first database 150, and/or the second database 160. Additionally, while FIG. 1 illustrates certain components as separate, standalone entities communicating over the network 130, various embodiments are not limited to this configuration. In other embodiments, one or more components may be directly connected and/or share hardware or the like.

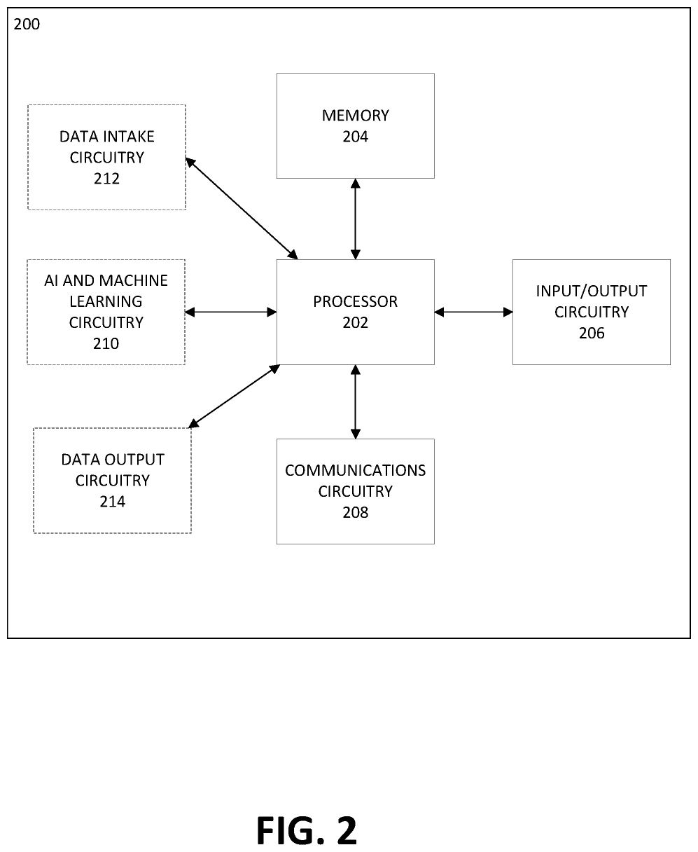

FIG. 2 illustrates an exemplary block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud based computing apparatus, a specifically configured embedded computing device (e.g., configured for edge computing), and/or the like. Examples of an apparatus 200 may include, but is not limited to, the apparatus for backfilling sensor data 140, the sensors 110, the first database 150, and/or the second database 160. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 200 of an apparatus for backfilling sensor data 140 and/or the sensors 110 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuitry 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the one or more assets 102. In some embodiments, the data intake circuitry 212 includes hardware, software, firmware, and/or a combination thereof, that communicates with one or more sensor(s) component(s), and/or the like within the one or more sensors 110, the one or more assets 102, the first database 150, and/or the second database 160 to receive particular data associated with such operations of the one or more sensors 110, the one or more assets 102, the first database 150, and/or the second database 160. Additionally or alternatively, in some embodiments, the data intake circuitry 212 includes hardware, software, firmware, and/or a combination thereof, that retrieves particular data associated with one or more sensors 110, the one or more assets 102, the first database 150, and/or the second database 160 from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured to facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect the AI and machine learning circuitry 210.

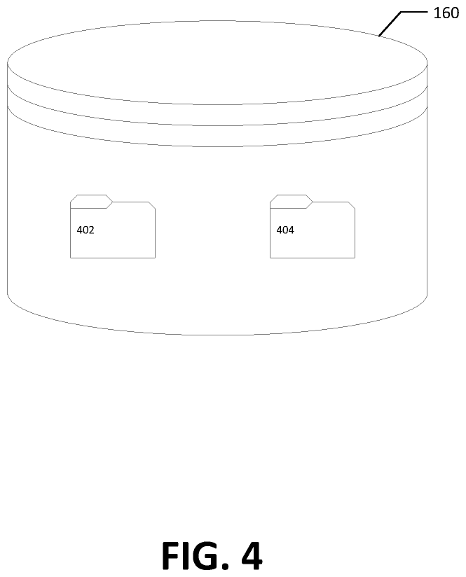

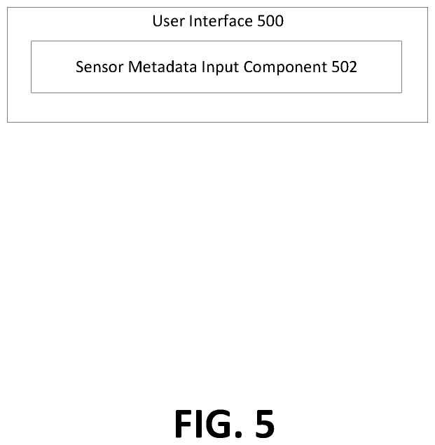

With reference to FIGS. 1-5, in some embodiments, the apparatus for backfilling sensor data 140 may be configured to receive sensor data from at least one of the one or more sensors 110 (e.g., via the network 130). In some embodiments, the sensor data may represent the operations of the one or more assets 102 associated with the at least one of the one or more sensors 110. For example, if the at least one sensor of the one or more sensors is a particulate matter sensor, the sensor data may include particulate matter data associated with an associated asset of the one or more assets 102. In some embodiments, the apparatus for backfilling sensor data 140 may be configured to receive the sensor data in real-time. In this regard, for example, the apparatus for backfilling sensor data 140 may be configured to receive the sensor data as a sensor in the one or more sensors 110 captures the sensor data (e.g., the one or more sensors are configured to stream the sensor data to the apparatus for backfilling sensor data 140).

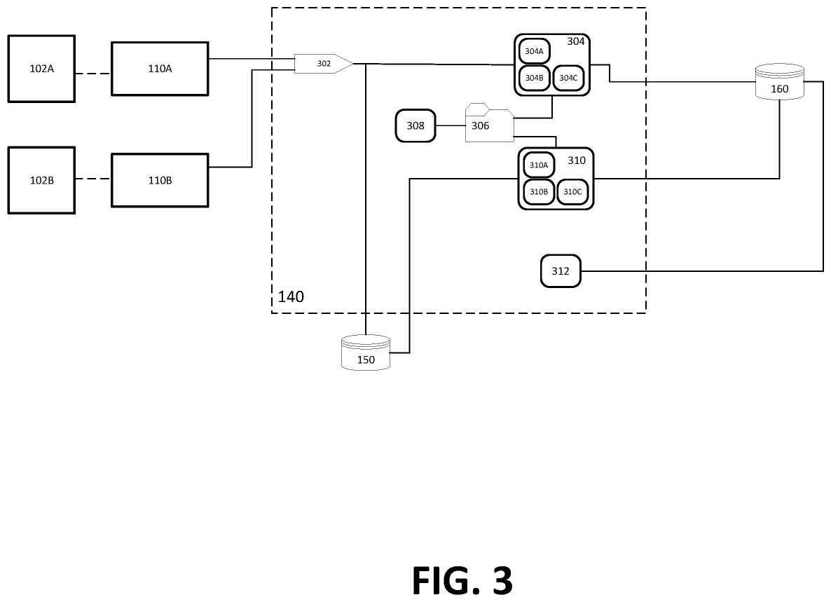

In some embodiments, the apparatus for backfilling sensor data 140 may be configured to receive the sensor data via a sensor data input port 302. In this regard, the apparatus for backfilling sensor data 140 may be configured to receive the sensor data via the sensor data input port 302 from each of the one or more sensors 110. For example, such as illustrated in FIG. 3, if the one or more sensors 110 include two sensors, such as a sensor 110A associated with an asset 102A and a sensor 110B associated with an asset 102B, the apparatus for backfilling sensor data 140 may be configured to receive the sensor data via the sensor data input port 302 from the sensor 110A and the sensor 110B.

In some embodiments, the apparatus for backfilling sensor data 140 may be configured to generate improved sensor data. In some embodiments, generating the improved sensor data may include processing the sensor data in a first sensor data processing unit 304. In some embodiments, the first sensor data processing unit 304 may be configured to processes the sensor data by performing one or more of ontology processing, normalization processing, and/or interpolation processing. For example, the apparatus for backfilling sensor data 140, using the first sensor data processing unit 304, may be configured to generate improved sensor data at least in part by performing ontology processing, normalization processing, and/or interpolation processing. In some embodiments, the first sensor data processing unit 304 may be configured to process the sensor data in real-time. In this regard, the first sensor data processing unit 304 may be configured to processes the sensor data as the apparatus for backfilling sensor data 140 receives the sensor data. For example, the apparatus for backfilling sensor data 140 may be configured to processes a stream of sensor data received by the sensor data input port 302 from at least one of the one or more sensors 110.

In some embodiments, the first sensor data processing unit 304 may include first ontology circuitry 304A configured to perform ontology processing. In this regard, for example, the first ontology circuitry 304A may be configured to associate first sensor metadata with the sensor data (e.g., the ontology processing may include associating first sensor metadata with the sensor data).

In some embodiments, the first sensor metadata may be received by the first ontology circuitry 304A from a sensor metadata repository 306. In some embodiments, the sensor metadata repository 306 may comprise a relational database. In this regard, for example, the first sensor metadata in the sensor metadata repository 306 may be in a relational database format. In some embodiments, the sensor metadata repository 306 may receive the first sensor metadata from a sensor metadata source 308. In some embodiments, the sensor metadata source 308 may comprise a graphical database. In this regard, for example, the first sensor metadata in the sensor metadata source 308 may be in a graphical database format. In some embodiments, the sensor metadata repository 306 may be configured to convert the first sensor metadata from a graphical database format to a relational database format.

In some embodiments, the sensor metadata source 308 may be configured to receive the first sensor metadata via a user interface 500. In this regard, the apparatus for backfilling sensor data 140 may be configured to cause the user interface 500 to be displayed such that a user associated with the apparatus for backfilling sensor data 140 may be able to provide the first sensor metadata to the sensor metadata source 308. In some embodiments, the user interface 500 may include a sensor metadata input component 502. In this regard, for example, a user associated with the apparatus for backfilling sensor data 140 may enter the first sensor metadata associated with at least one of the one or more sensors 110 via the sensor metadata input component 502. First sensor metadata entered via the sensor metadata input component 502 may be stored in the sensor metadata source 308.

In some embodiments, associating first sensor metadata with the sensor data may include associating the sensor data with characteristics of the one or more sensors 110 that the sensor data was received from. For example, in the example illustrated in FIG. 3, the first ontology circuitry 304A may be configured to associate first sensor metadata associated with sensor 110A with sensor data received from the sensor 110A. In this regard, for example, the first ontology circuitry 304A may associate sensor data received from the sensor 110A with first sensor metadata associated with the sensor 110A. For example, the first sensor metadata may include metadata indicating one or more of a sensor type (e.g., what type of sensor the sensor 110A is, such as a temperature sensor), a sensor role (e.g., what the role of the sensor 110A is in relation to the asset 102A, such as a temperature sensor configured to capture the temperature inside an air handling unit associated with the asset 102A), a sensor configuration (e.g., how the sensor 110A is configured to capture sensor data, such as a virtual sensor configured to determine sensor data from other data), an asset location (e.g., the location of the asset 102A associated with the sensor 110A), a location of the sensor 110A within the asset 102A (e.g., where within the asset 102A the sensor 110A is located), an age of the sensor 110A (e.g., how old the sensor 110A is, such as one year old), a device identification (e.g., an identification that uniquely identifies the sensor 110A), a manufacturer of the sensor 110A, and/or the like.

In some embodiments, the first sensor data processing unit 304 may include first normalization circuitry 304B configured to perform normalization processing. In this regard, for example, the sensor data received from each of the one or more sensors 110 may be in a non-normalized format when received by the sensor data input port 302. For example, sensor data received from sensor 110A may be in a first non-normalized format and sensor data received from sensor 110B may be in a second non-normalized format. In this regard, for example, the first normalization circuitry 304B may be configured to process sensor data in a non-normalized format into sensor data in a normalized format. For example, sensor data in a non-normalized format received from sensor 110A and sensor data in a non-normalized format received from sensor 110B may be processed into a normalized format by the first normalization circuitry 304B.

In some embodiments, first sensor data processing unit 304 may include first interpolation circuitry 304C configured to perform interpolation processing. In this regard, for example, the sensor data received from each of the one or more sensors 110 may be incomplete (e.g., there are gaps in the sensor data). In some embodiments, the first interpolation circuitry 304C may be configured to complete the sensor data by performing interpolation processing (e.g., fill in the gaps in the sensor data). For example, the sensor data may include a plurality of temperatures determined by the sensor 110A on a per second basis over a 1 minute time period (e.g., when the sensor 110A includes a temperature sensor). However, the sensor data may not include a temperature for 1 second during the 1 minute time period (e.g., the sensor data may not include a temperature reading for the 39^{th} second in the 1 minute time period). In this regard, for example, the first interpolation circuitry 304C may be configured to determine the temperature for the 1 second during the 1 minute time period for which the sensor data did not include a temperature by performing interpolation processing (e.g., the first interpolation circuitry 304C may determine the temperature for the 39^{th} second by performing interpolation processing).

In some embodiments, the apparatus for backfilling sensor data 140 may be configured to route the sensor data to the first database 150. In this regard, for example, the apparatus for backfilling sensor data 140 may be configured to route the sensor data to the first database 150 such that the sensor data may be stored in the first database 150. In some embodiments, the apparatus for backfilling sensor data 140 may be configured to route the sensor data to the first database 150 during the first time-period. In some embodiments, the apparatus for backfilling sensor data 140 may be configured to route the sensor data to the first database 150 after the improved sensor data has been generated. In some embodiments, the first database 150 may be a time series database.

In some embodiments, the apparatus for backfilling sensor data 140 may be configured to route the improved sensor data to the second database 160. In this regard, for example, the apparatus for backfilling sensor data 140 may be configured to route the improved sensor data to the second database 160 such that the improved sensor data may be stored in the second database 160. In some embodiments, the apparatus for backfilling sensor data 140 may be configured to route the improved sensor data to a first container 402 in the second database 160 (e.g., the first container 402 being a sub storage unit in the second database 160). In this regard, for example, the apparatus for backfilling sensor data 140 may be configured to route the improved sensor data to the first container 402 in the second database 160 such that the improved sensor data may be stored in the first container 402 in the second database 160.

In some embodiments, the apparatus for backfilling sensor data 140 may be configured to route the improved sensor data to the second database 160 during the first time-period. For example, the apparatus for backfilling sensor data 140 may be configured to route the improved sensor data to the second database 160 after the first sensor data processing unit 304 has generated the improved sensor data. In some embodiments, the second database 160 may be a time series database.

In some embodiments, the apparatus for backfilling sensor data 140 may be configured to receive second sensor metadata. In some embodiments, the second sensor metadata may be different that the first sensor metadata. In some embodiments, the second sensor metadata may be received during a second time period. The second time period may be a time period that is different that the first time period. For example, the second time period may occur after the first time period.

In some embodiments, the apparatus for backfilling sensor data 140 may be configured to retrieve the sensor data from the first database 150 (e.g., the sensor data being the data received from at least one of the one or more sensors 110 that has not been processed by the first sensor data processing unit 304). In some embodiments, the apparatus for backfilling sensor data 140 may be configured to retrieve the sensor data from the first database 150 in response to the apparatus for backfilling sensor data 140 receiving the second sensor metadata.

In some embodiments, the apparatus for backfilling sensor data 140 may be configured to generate updated improved sensor data. In some embodiments, generating the updated improved sensor data may include processing the sensor data in a second sensor data processing unit 310 (e.g., processing the sensor data retrieved from the first database 150). In some embodiments, the second sensor data processing unit 310 may be configured to processes the sensor data by performing one or more of ontology processing, normalization processing, and/or interpolation processing. For example, the apparatus for backfilling sensor data 140, using the second sensor data processing unit 310, may be configured to generate updated improved sensor data at least in part by performing ontology processing, normalization processing, and/or interpolation processing. In some embodiments, the second sensor data processing unit 310 may be configured to process the sensor data in real-time. In this regard, the second sensor data processing unit 310 may be configured to processes the sensor data as the second sensor data processing unit 310 receives the sensor data from the first database 150. For example, the second sensor data processing unit 310 may be configured to processes a stream of sensor data received by the second sensor data processing unit 310 from the first database 150.

In some embodiments, the second sensor data processing unit 310 may include second ontology circuitry 310A configured to perform ontology processing. In this regard, for example, the second ontology circuitry 310A may be configured to associate second sensor metadata with the sensor data (e.g., the ontology processing may include associating second sensor metadata with the sensor data).

In some embodiments, the second sensor metadata may be received by the second ontology circuitry 310A from the sensor metadata repository 306. In some embodiments, as described above, the sensor metadata repository 306 may comprise a relational database. In this regard, for example, the second sensor metadata in the sensor metadata repository 306 may be in a relational database format. In some embodiments, as described above, the sensor metadata repository 306 may receive the second sensor metadata from the sensor metadata source 308. In some embodiments, the sensor metadata source 308 may comprise a graphical database. In this regard, for example, the second sensor metadata in the sensor metadata source 308 may be in a graphical database format. In some embodiments, the sensor metadata repository 306 may be configured to convert the second sensor metadata from a graphical database format to a relational database format.

In some embodiments, the sensor metadata source 308 may be configured to receive the second sensor metadata via the user interface 500. In this regard, the apparatus for backfilling sensor data 140 may be configured to cause the user interface 500 to be displayed such that a user associated with the apparatus for backfilling sensor data 140 may provide the second sensor metadata to the sensor metadata source 308. In some embodiments, the user interface 500 may include the sensor metadata input component 502. In this regard, for example, a user associated with the apparatus for backfilling sensor data 140 may enter the second sensor metadata associated with at least one of the one or more sensors 110 via the sensor metadata input component 502. Second sensor metadata entered via the sensor metadata input component 502 may be stored in the sensor metadata source 308.

In some embodiments, associating second sensor metadata with the sensor data may include associating the sensor data with characteristics of the one or more sensors 110 that the sensor data was received from. For example, in the example illustrated in FIG. 3, the second ontology circuitry 310A may be configured to associate second sensor metadata associated with sensor 110A with sensor data received from the sensor 110A. In this regard, for example, the second ontology circuitry 310A may associate sensor data received from the sensor 110A with second sensor metadata associated with the sensor 110A. For example, the second sensor metadata may include metadata indicating one or more of a sensor type (e.g., what type of sensor the sensor 110A is, such as a temperature sensor), a sensor role (e.g., what the role of the sensor 110A is in relation to the asset 102A, such as a temperature sensor configured to capture the temperature inside an air handling unit associated with the asset 102A), a sensor configuration (e.g., how the sensor 110A is configured to capture sensor data, such as a virtual sensor configured to determine sensor data from other data), an asset location (e.g., the location of the asset 102A associated with the sensor 110A), a location of the sensor 110A within the asset 102A (e.g., where within the asset 102A the sensor 110A is located), an age of the sensor 110A (e.g., how old the sensor 110A is, such as one year old), a device identification (e.g., an identification that uniquely identifies the sensor 110A), a manufacturer of the sensor 110A, and/or the like.

In some embodiments, the second sensor data processing unit 310 may include second normalization circuitry 310B configured to perform normalization processing. In this regard, for example, the sensor data received from each of the one or more sensors 110 may be in a non-normalized format when received by the sensor data input port 302 and/or when stored in the first database 150. For example, sensor data received from sensor 110A may be in a first non-normalized format and sensor data received from sensor 110B may be in a second non-normalized format. In this regard, for example, the second normalization circuitry 310B may be configured to process sensor data in a non-normalized format into sensor data in a normalized format. For example, sensor data in a non-normalized format received from sensor 110A and sensor data in a non-normalized format received from sensor 110B may be processed into a normalized format by the second normalization circuitry 310B.

In some embodiments, second sensor data processing unit 310 may include second interpolation circuitry 310C configured to perform interpolation processing. In this regard, for example, the sensor data received from each of the one or more sensors 110 may be incomplete (e.g., there are gaps in the sensor data). In some embodiments, the second interpolation circuitry 310C may be configured to complete the sensor data by performing interpolation processing (e.g., fill in the gaps in the sensor data). For example, the sensor data may include a plurality of temperatures determined by the sensor 110A on a per second basis over a 1 minute time period (e.g., when the sensor 110A includes a temperature sensor). However, the sensor data may not include a temperature for 1 second during the 1 minute time period (e.g., the sensor data may not include a temperature reading for the 39^{th} second in the 1 minute time period). In this regard, for example, the second interpolation circuitry 310C may be configured to determine the temperature for the 1 second during the 1 minute time period for which the sensor data did not include a temperature by performing interpolation processing (e.g., the second interpolation circuitry 310C may determine the temperature for the 39^{th} second by performing interpolation processing).

In some embodiments, the apparatus for backfilling sensor data 140 may be configured to route the updated improved sensor data to the second database 160. In this regard, for example, the apparatus for backfilling sensor data 140 may be configured to route the updated improved sensor data to the second database 160 such that the updated improved sensor data may be stored in the second database 160. In some embodiments, the apparatus for backfilling sensor data 140 may be configured to route the updated improved sensor data to a second container 404 in the second database 160 (e.g., the second container 404 being a sub storage unit in the second database 160). In this regard, for example, the apparatus for backfilling sensor data 140 may be configured to route the updated improved sensor data to the second container 404 in the second database 160 such that the updated improved sensor data may be stored in the second container 404 in the second database 160. In some embodiments, the second container 404 in the second database 160 may be configured to store the updated improved sensor data for at least a temporary time period.

In some embodiments, the apparatus for backfilling sensor data 140 may be configured to generate an ingestion specification. In some embodiments, the apparatus for backfilling sensor data 140 may include an ingestion specification unit 312 configured to generate the ingestion specification. In some embodiments, the ingestion specification may be configured to instruct the second database 160 to overwrite at least a portion of the improved sensor data in the first container 402 of the second database 160 with at least a portion of the updated improved sensor data.

In some embodiments, based at least in part on the ingestion specification, the second database 160 may be configured to overwrite all of the improved sensor data with the updated improved sensor data. In other embodiments, based at least in part on the ingestion specification, the second database 160 may be configured to overwrite only some of the improved sensor data with some of the updated improved sensor data (e.g., a corresponding portion of the updated improved sensor data). For example, if the first sensor metadata indicates that a sensor in the one or more sensors 110 is located on the first floor of the asset and the second sensor metadata indicates that the sensor in the one or more sensors 110 is located on the second floor of the asset (e.g., the sensor has been moved from the first floor to the second floor of the asset), the second database 160, based at least in part on the ingestion specification, may not be configured to overwrite at least a portion of the improved sensor data associated with the sensor being on the first floor of the asset. As another example, if the first sensor metadata indicates that a sensor in the one or more sensors 110 captured temperature data in Celsius and the second sensor metadata indicates that the sensor in the one or more sensors 110 actually captured temperature data in Fahrenheit, the second database 160, based at least in part on the ingestion specification, may be configured to overwrite at least a portion of the improved sensor data associated with the temperature data with the updated improved sensor data. As another example, if the first sensor metadata indicates that a sensor in the one or more sensors 110 has a first sensor configuration and the second sensor metadata indicates that the sensor in the one or more sensors 110 actually had a second sensor configuration, the second database 160, based at least in part on the ingestion specification, may be configured to overwrite at least a portion of the improved sensor data associated with the first sensor configuration with the updated improved sensor data.

In some embodiments, the apparatus for backfilling sensor data 140 may be configured to transmit the ingestion specification to the second database 160. In this regard, for example, the apparatus for backfilling sensor data 140 may be configured to cause the second database 160 to overwrite at least a portion of the improved sensor data in the first container 402 with at least a portion of the updated improved sensor data in the second container 404 based at least in part by transmitting the ingestion specification to the second database 160.

In some embodiments, the apparatus for backfilling sensor data 140 may be configured to receive second sensor data from one or more of the one or more sensors 110 during the second time period. In this regard, for example, the second sensor data may represent the operations of the one or more assets 102 associated with the at least one of the one or more sensors 110 during the second time period. For example, if the at least one sensor of the one or more sensors 110 is a temperature sensor, the second sensor data may include temperature data associated with an asset of the one or more assets (e.g., temperature data associated with the second-time period). In some embodiments, the apparatus for backfilling sensor data 140 may be configured to receive the second sensor data in real-time. In this regard, for example, the apparatus for backfilling sensor data 140 may be configured to receive the second sensor data as a sensor in the one or more sensors 110 captures the second sensor data (e.g., the one or more sensors 110 are configured to stream the second sensor data to the apparatus for backfilling sensor data 140).

In some embodiments, the apparatus for backfilling sensor data 140 may be configured to receive the second sensor data via the sensor data input port 302. In this regard, the apparatus for backfilling sensor data 140 may be configured to receive the second sensor data via the sensor data input port 302 from each of the one or more sensors 110. For example, such as illustrated in FIG. 3, if the one or more sensors 110 include two sensors, such as the sensor 110A and the sensor 110B, the apparatus for backfilling sensor data 140 may be configured to receive the second sensor data via the sensor data input port 302 from the sensor 110A and the sensor 110B.

In some embodiments, the apparatus for backfilling sensor data 140 may be configured to generate second improved sensor data. In some embodiments, the apparatus for backfilling sensor data 140 may be configured to generate the second improved sensor data based at least in part on the second sensor metadata. In some embodiments, generating the second improved sensor data may include processing the second sensor data in the first sensor data processing unit 304. In some embodiments, the first sensor data processing unit 304 may be configured to processes the second sensor data by performing one or more of ontology processing, normalization processing, and/or interpolation processing. For example, the apparatus for backfilling sensor data 140, using the first sensor data processing unit 304, may be configured to generate second improved sensor data at least in part by performing ontology processing using the first ontology circuitry 304A, normalization processing using the first normalization circuitry 304B, and/or interpolation processing using the first interpolation circuitry 304C.

In some embodiments, the first sensor data processing unit 304 may be configured to process the second sensor data in real-time. In this regard, the first sensor data processing unit 304 may be configured to processes the second sensor data as the apparatus for backfilling sensor data 140 receives the second sensor data. For example, the apparatus for backfilling sensor data 140 may be configured to processes a stream of second sensor data received by the sensor data input port 302 from at least one of the one or more sensors 110.

In some embodiments, the first sensor data processing unit 304 may be configured to process the second sensor data during the second time period. In this regard, for example, the first sensor data processing unit 304 may be configured to process the second sensor data (e.g., to create the second improved sensor data) in the same time period (e.g., the second time period) as the second sensor data processing unit 310 is processing the sensor data to generate the updated improved sensor data. Said differently, by processing second sensor data in the first sensor data processing unit 304 and sensor data in the second sensor data processing unit 310, the apparatus for backfilling sensor data 140 may be configured to process both second sensor data to generate second improved sensor data and sensor data to generate updated improved sensor data in the same time period (e.g., the second time period) without impacting the processing and generation of either of the second improved sensor data or the updated improved sensor data. That is, the apparatus for backfilling sensor data 140 may be configured to simultaneously update previously received sensor data (e.g., the sensor data stored in the first database 150) based on new sensor metadata (e.g., the second sensor metadata) while still being able to process newly receive sensor data (e.g., the second sensor data) without introducing any processing delays or latency into the processing of newly received sensor data.

In some embodiments, the apparatus for backfilling sensor data 140 may be configured to route the second improved sensor data to the second database 160. In this regard, for example, the apparatus for backfilling sensor data 140 may be configured to route the second improved sensor data to the second database 160 such that the second improved sensor data may be stored in the second database 160. In some embodiments, the apparatus for backfilling sensor data 140 may be configured to route the second improved sensor data to the first container 402 in the second database 160. In this regard, for example, the apparatus for backfilling sensor data 140 may be configured to route the second improved sensor data to the first container 402 in the second database 160 such that the second improved sensor data may be stored in the first container 402 in the second database 160.

In some embodiments, the apparatus for backfilling sensor data 140 may be configured to route the second improved sensor data to the second database 160 during the second time-period. For example, the apparatus for backfilling sensor data 140 may be configured to route the second improved sensor data to the second database 160 after the first sensor data processing unit 304 has generated the second improved sensor data.

### Example Methods

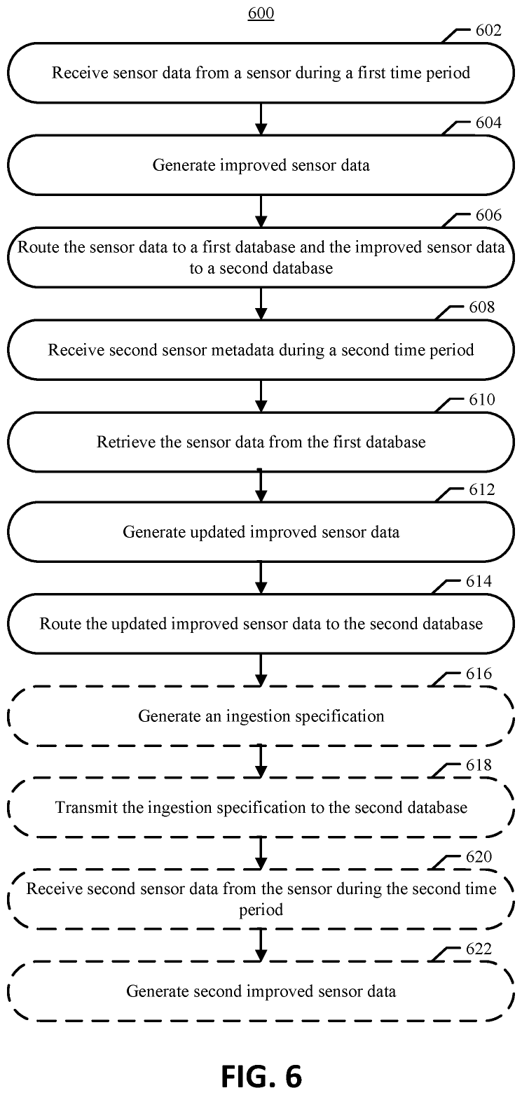

Referring now to FIG. 6, a flowchart providing an example computer-implemented method 600 is illustrated. In this regard, FIG. 6 illustrates operations that may be performed by one or more of the apparatus for backfilling sensor data 140, the one or more assets 102, the one or more sensors 110, the first database 150, the second database 160, and/or the like. In some embodiments, the example computer-implemented method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the computer-implemented method 600.

As shown in block 602, the computer-implemented method 600 may include receiving sensor data from a sensor during a first time period. As described above, in some embodiments, the sensor data may represent the operations of the one or more assets associated with the at least one of the one or more sensors. For example, if the at least one sensor of the one or more sensors is a particulate matter sensor, the sensor data may include particulate matter data associated with an associated asset of the one or more assets. In some embodiments, the sensor data may be received via a sensor data input port. In this regard, the sensor data may be received via the sensor data input port from each of the one or more sensors.

As shown in block 604, the computer-implemented method 600 may include generating improved sensor data. As described above, in some embodiments, generating the improved sensor data may include processing the sensor data in a first sensor data processing unit. In some embodiments, the first sensor data processing unit may be configured to processes the sensor data by performing one or more of ontology processing, normalization processing, and/or interpolation processing. For example, using the first sensor data processing unit, improved sensor data may be generated at least in part by performing ontology processing, normalization processing, and/or interpolation processing.

In some embodiments, the first sensor data processing unit may include first ontology circuitry configured to perform ontology processing. In this regard, for example, the first ontology circuitry may be configured to associate first sensor metadata with the sensor data (e.g., the ontology processing may include associating first sensor metadata with the sensor data).

In some embodiments, the first sensor metadata may be received by the first ontology circuitry from a sensor metadata repository. In some embodiments, the sensor metadata repository may comprise a relational database. In this regard, for example, the first sensor metadata in the sensor metadata repository may be in a relational database format. In some embodiments, the sensor metadata repository may receive the first sensor metadata from a sensor metadata source. In some embodiments, the sensor metadata source may comprise a graphical database. In this regard, for example, the first sensor metadata in the sensor metadata source may be in a graphical database format. In some embodiments, the sensor metadata repository may be configured to convert the first sensor metadata from a graphical database format to a relational database format.

In some embodiments, the sensor metadata source may be configured to receive the first sensor metadata via a user interface. In this regard, the user interface may be caused to be displayed such that a user may be able to provide the first sensor metadata to the sensor metadata source. In some embodiments, the user interface may include a sensor metadata input component. In this regard, for example, a user may enter the first sensor metadata associated with at least one of the one or more sensors via the sensor metadata input component. First sensor metadata entered via the sensor metadata input component may be stored in the sensor metadata source.

In some embodiments, associating first sensor metadata with the sensor data may include associating the sensor data with characteristics of the one or more sensors that the sensor data was received from. For example, the first ontology circuitry may be configured to associate first sensor metadata associated with a first sensor with sensor data received from the first sensor. In this regard, for example, the first ontology circuitry may associate sensor data received from the first sensor with first sensor metadata associated with the first sensor. For example, the first sensor metadata may include metadata indicating one or more of a sensor type (e.g., what type of sensor the first sensor is, such as a temperature sensor), a sensor role (e.g., what the role of the first sensor is in relation to the first asset, such as a temperature sensor configured to capture the temperature inside an air handling unit associated with the first asset), a sensor configuration (e.g., how the first sensor is configured to capture sensor data, such as a virtual sensor configured to determine sensor data from other data), an asset location (e.g., the location of the first asset associated with the first sensor), a location of the first sensor within the first asset (e.g., where within the first asset the first sensor is located), an age of the first sensor (e.g., how old the first sensor is, such as one year old), a device identification (e.g., an identification that uniquely identifies the first sensor), a manufacturer of the first sensor, and/or the like.

In some embodiments, the first sensor data processing unit may include first normalization circuitry configured to perform normalization processing. In this regard, for example, the sensor data received from each of the one or more sensors may be in a non-normalized format when received by the sensor data input port. For example, sensor data received from first sensor may be in a first non-normalized format and sensor data received from second sensor may be in a second non-normalized format. In this regard, for example, the first normalization circuitry may be configured to process sensor data in a non-normalized format into sensor data in a normalized format. For example, sensor data in a non-normalized format received from first sensor and sensor data in a non-normalized format received from second sensor may be processed into a normalized format by the first normalization circuitry.

In some embodiments, first sensor data processing unit may include first interpolation circuitry configured to perform interpolation processing. In this regard, for example, the sensor data received from each of the one or more sensors may be incomplete (e.g., there are gaps in the sensor data). In some embodiments, the first interpolation circuitry may be configured to complete the sensor data by performing interpolation processing (e.g., fill in the gaps in the sensor data). For example, the sensor data may include a plurality of temperatures determined by the first sensor on a per second basis over a 1 minute time period (e.g., when the first sensor includes a temperature sensor). However, the sensor data may not include a temperature for 1 second during the 1 minute time period (e.g., the sensor data may not include a temperature reading for the 39^{th} second in the 1 minute time period). In this regard, for example, the first interpolation circuitry may be configured to determine the temperature for the 1 second during the 1 minute time period for which the sensor data did not include a temperature by performing interpolation processing (e.g., the first interpolation circuitry may determine the temperature for the 39^{th} second by performing interpolation processing).

As shown in block 606, the computer-implemented method 600 may include routing the sensor data to a first database and the improved sensor data to a second database. The sensor data may be routed to the first database such that the sensor data may be stored in the first database. In some embodiments, the sensor data may be routed to the first database during the first time-period. In some embodiments, the sensor data may be routed to the first database after the improved sensor data has been generated. In some embodiments, the first database may be a time series database.

In some embodiments, the improved sensor data may be routed to the second database. In this regard, for example, the improved sensor data may be routed to the second database such that the improved sensor data may be stored in the second database. In some embodiments, the improved sensor data may be routed to a first container in the second database (e.g., the first container being a sub storage unit in the second database). In this regard, for example, the improved sensor data may be routed to the first container in the second database such that the improved sensor data may be stored in the first container in the second database.

As shown in block 608, the computer-implemented method 600 may include receiving second sensor metadata during a second time period. As described above, in some embodiments, the second sensor metadata may be different that the first sensor metadata. In some embodiments, the second sensor metadata may be received during a second time period. The second time period may be a time period that is different that the first time period. For example, the second time period may occur after the first time period.

As shown in block 610, the computer-implemented method 600 may include retrieving the sensor data from the first database. As described above, in some embodiments, the sensor data may be retrieved from the first database in response to receiving the second sensor metadata.

As shown in block 612, the computer-implemented method 600 may include generating updated improved sensor data. As described above, in some embodiments, generating the updated improved sensor data may include processing the sensor data in a second sensor data processing unit (e.g., processing the sensor data retrieved from the first database). In some embodiments, the second sensor data processing unit may be configured to processes the sensor data by performing one or more of ontology processing, normalization processing, and/or interpolation processing. For example, using the second sensor data processing unit, updated improved sensor data may be generated at least in part by performing ontology processing, normalization processing, and/or interpolation processing.

In some embodiments, the second sensor data processing unit may include second ontology circuitry configured to perform ontology processing. In this regard, for example, the second ontology circuitry may be configured to associate second sensor metadata with the sensor data (e.g., the ontology processing may include associating second sensor metadata with the sensor data).

In some embodiments, the second sensor metadata may be received by the second ontology circuitry from the sensor metadata repository. In some embodiments, as described above, the sensor metadata repository may comprise a relational database. In this regard, for example, the second sensor metadata in the sensor metadata repository may be in a relational database format. In some embodiments, as described above, the sensor metadata repository may receive the second sensor metadata from the sensor metadata source. In some embodiments, the sensor metadata source may comprise a graphical database. In this regard, for example, the second sensor metadata in the sensor metadata source may be in a graphical database format. In some embodiments, the sensor metadata repository may be configured to convert the second sensor metadata from a graphical database format to a relational database format.

In some embodiments, the sensor metadata source may be configured to receive the second sensor metadata via the user interface. In this regard, the user interface may be caused to be displayed such that a user may provide the second sensor metadata to the sensor metadata source. In some embodiments, the user interface may include the sensor metadata input component. In this regard, for example, a user may enter the second sensor metadata associated with at least one of the one or more sensors via the sensor metadata input component. Second sensor metadata entered via the sensor metadata input component may be stored in the sensor metadata source.

In some embodiments, associating second sensor metadata with the sensor data may include associating the sensor data with characteristics of the one or more sensors that the sensor data was received from. For example, the second ontology circuitry may be configured to associate second sensor metadata associated with a first sensor with sensor data received from the first sensor. In this regard, for example, the second ontology circuitry may associate sensor data received from the first sensor with second sensor metadata associated with the first sensor. For example, the second sensor metadata may include metadata indicating one or more of a sensor type (e.g., what type of sensor the first sensor is, such as a temperature sensor), a sensor role (e.g., what the role of the first sensor is in relation to the first asset, such as a temperature sensor configured to capture the temperature inside an air handling unit associated with the first asset), a sensor configuration (e.g., how the first sensor is configured to capture sensor data, such as a virtual sensor configured to determine sensor data from other data), an asset location (e.g., the location of the first asset associated with the first sensor), a location of the first sensor within the first asset (e.g., where within the first asset the first sensor is located), an age of the first sensor (e.g., how old the first sensor is, such as one year old), a device identification (e.g., an identification that uniquely identifies the first sensor), a manufacturer of the first sensor, and/or the like.

In some embodiments, the second sensor data processing unit may include second normalization circuitry configured to perform normalization processing. In this regard, for example, the sensor data received from each of the one or more sensors may be in a non-normalized format when received by the sensor data input port and/or when stored in the first database. For example, sensor data received from first sensor may be in a first non-normalized format and sensor data received from second sensor may be in a second non-normalized format. In this regard, for example, the second normalization circuitry may be configured to process sensor data in a non-normalized format into sensor data in a normalized format. For example, sensor data in a non-normalized format received from first sensor and sensor data in a non-normalized format received from second sensor may be processed into a normalized format by the second normalization circuitry.

In some embodiments, second sensor data processing unit may include second interpolation circuitry configured to perform interpolation processing. In this regard, for example, the sensor data received from each of the one or more sensors may be incomplete (e.g., there are gaps in the sensor data). In some embodiments, the second interpolation circuitry may be configured to complete the sensor data by performing interpolation processing (e.g., fill in the gaps in the sensor data). For example, the sensor data may include a plurality of temperatures determined by the first sensor on a per second basis over a 1 minute time period (e.g., when the first sensor includes a temperature sensor). However, the sensor data may not include a temperature for 1 second during the 1 minute time period (e.g., the sensor data may not include a temperature reading for the 39^{th} second in the 1 minute time period). In this regard, for example, the second interpolation circuitry may be configured to determine the temperature for the 1 second during the 1 minute time period for which the sensor data did not include a temperature by performing interpolation processing (e.g., the second interpolation circuitry may determine the temperature for the 39th second by performing interpolation processing).

As shown in block 614, the computer-implemented method 600 may include routing the updated improved sensor data to the second database. As described above, in some embodiments, the updated improved sensor data may be routed to the second database such that the updated improved sensor data may be stored in the second database. In some embodiments, the updated improved sensor data may be routed to a second container in the second database (e.g., the second container being a sub storage unit in the second database). In this regard, for example, the updated improved sensor data may be routed to the second container in the second database such that the updated improved sensor data may be stored in the second container in the second database. In some embodiments, the second container in the second database may be configured to store the updated improved sensor data for at least a temporary time period.

As shown in block 616, the computer-implemented method 600 may optionally include generating an ingestion specification. As described above, in some embodiments, an ingestion specification unit may be configured to generate the ingestion specification. In some embodiments, the ingestion specification may be configured to instruct the second database to overwrite at least a portion of the improved sensor data in the first container of the second database with at least a portion of the updated improved sensor data.

In some embodiments, based at least in part on the ingestion specification, the second database may be configured to overwrite all of the improved sensor data with the updated improved sensor data. In other embodiments, based at least in part on the ingestion specification, the second database may be configured to overwrite only some of the improved sensor data with some of the updated improved sensor data (e.g., a corresponding portion of the updated improved sensor data). For example, if the first sensor metadata indicates that a sensor in the one or more sensors is located on the first floor of the asset and the second sensor metadata indicates that the sensor in the one or more sensors is located on the second floor of the asset (e.g., the sensor has been moved from the first floor to the second floor of the asset), the second database, based at least in part on the ingestion specification, may not be configured to overwrite at least a portion of the improved sensor data associated with the sensor being on the first floor of the asset. As another example, if the first sensor metadata indicates that a sensor in the one or more sensors captured temperature data in Celsius and the second sensor metadata indicates that the sensor in the one or more sensors actually captured temperature data in Fahrenheit, the second database, based at least in part on the ingestion specification, may be configured to overwrite at least a portion of the improved sensor data associated with the temperature data with the updated improved sensor data. As another example, if the first sensor metadata indicates that a sensor in the one or more sensors has a first sensor configuration and the second sensor metadata indicates that the sensor in the one or more sensors actually had a second sensor configuration, the second database, based at least in part on the ingestion specification, may be configured to overwrite at least a portion of the improved sensor data associated with the first sensor configuration with the updated improved sensor data.

As shown in block 618, the computer-implemented method 600 may optionally include transmitting the ingestion specification to the second database. As described above, in some embodiments, the second database may be caused to overwrite at least a portion of the improved sensor data in the first container with at least a portion of the updated improved sensor data in the second container based at least in part by transmitting the ingestion specification to the second database.

As shown in block 620, the computer-implemented method 600 may optionally include receiving second sensor data from the sensor during the second time period. As described above, in some embodiments, the second sensor data may represent the operations of the one or more assets associated with the at least one of the one or more sensors during the second time period. For example, if the at least one sensor of the one or more sensors is a temperature sensor, the second sensor data may include temperature data associated with an asset of the one or more assets (e.g., temperature data associated with the second-time period).

In some embodiments, the second sensor data may be received via the sensor data input port. In this regard, the second sensor data may be received via the sensor data input port from each of the one or more sensors.

As shown in block 622, the computer-implemented method 600 may optionally include generating second improved sensor data. As described above, in some embodiments, the second improved sensor data may be generated based at least in part on the second sensor metadata. In some embodiments, generating the second improved sensor data may include processing the second sensor data in the first sensor data processing unit. In some embodiments, the first sensor data processing unit may be configured to processes the second sensor data by performing one or more of ontology processing, normalization processing, and/or interpolation processing. For example, using the first sensor data processing unit, second improved sensor data may be generated at least in part by performing ontology processing using the first ontology circuitry, normalization processing using the first normalization circuitry, and/or interpolation processing using the first interpolation circuitry.

In some embodiments, the first sensor data processing unit may be configured to process the second sensor data during the second time period. In this regard, for example, the first sensor data processing unit may be configured to process the second sensor data (e.g., to create the second improved sensor data) in the same time period (e.g., the second time period) as the second sensor data processing unit is processing the sensor data to generate the updated improved sensor data. Said differently, by processing second sensor data in the first sensor data processing unit and sensor data in the second sensor data processing unit, both second sensor data may be processed to generate second improved sensor data and sensor data may be processed to generate updated improved sensor data in the same time period (e.g., the second time period) without impacting the processing and generation of either of the second improved sensor data or the updated improved sensor data. That is, it may be possible to simultaneously update previously received sensor data (e.g., the sensor data stored in the first database) based on new sensor metadata (e.g., the second sensor metadata) while still being able to process newly receive sensor data (e.g., the second sensor data) without introducing any processing delays or latency into the processing of newly received sensor data.

In some embodiments, the second improved sensor data may be routed to the second database. In this regard, for example, the second improved sensor data may be routed to the second database such that the second improved sensor data may be stored in the second database. In some embodiments, the second improved sensor data may be routed to the first container in the second database. In this regard, for example, the second improved sensor data may be routed to the first container in the second database such that the second improved sensor data may be stored in the first container in the second database.

In some embodiments, the second improved sensor data may be routed to the second database during the second time-period. For example, the second improved sensor data may be routed to the second database after the first sensor data processing unit has generated the second improved sensor data.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

That which is claimed:

1. A computer-implemented method comprising:
receiving sensor data from a sensor during a first time period;
generating improved sensor data, wherein generating the improved sensor data comprises processing the sensor data in a first sensor data processing unit based at least in part on first sensor metadata;
routing the sensor data to a first database and the improved sensor data to a second database;
receiving second sensor metadata during a second time period;
retrieving the sensor data from the first database;
generating updated improved sensor data, wherein generating the updated improved sensor data comprises processing the sensor data in a second sensor data processing unit based at least in part on the second sensor metadata; and
routing the updated improved sensor data to the second database.

2. The computer-implemented method of claim 1, wherein the improved sensor data is routed to a first container in the second database.

3. The computer-implemented method of claim 2, wherein the updated improved sensor data is routed to a second container in the second database.

4. The computer-implemented method of claim 3, further comprising:
generating an ingestion specification, wherein the ingestion specification is configured to instruct the second database to overwrite at least a portion of the improved sensor data in the first container with at least a portion of the updated improved sensor data in the second container; and
transmitting the ingestion specification to the second database.

5. The computer-implemented method of claim 1, wherein the first sensor data processing unit comprises at least one of first ontology circuitry, first normalization circuitry, or first interpolation circuitry and the second sensor data processing unit comprises at least one of second ontology circuitry, second normalization circuitry, or second interpolation circuitry.

6. The computer-implemented method of claim 5, wherein the first ontology circuitry is configured to associate the first sensor metadata with the sensor data.

7. The computer-implemented method of claim 5, wherein the second ontology circuitry is configured to associate the second sensor metadata with the sensor data.

8. The computer-implemented method of claim 1, wherein the second database is a time series database.

9. The computer-implemented method of claim 1, wherein generating the improved sensor data occurs in real-time.

10. The computer-implemented method of claim 1, further comprising:
receiving second sensor data from the sensor during the second time period; and
generating second improved sensor data, wherein generating the second improved sensor data comprises processing the second sensor data in the first sensor data processing unit based at least in part on the second sensor metadata.

11. An apparatus comprising at least one processor and at least one memory coupled to the at least one processor, wherein the at least one processor is configured to:
receive sensor data from a sensor during a first time period;
generate improved sensor data, wherein generating the improved sensor data comprises processing the sensor data in a first sensor data processing unit based at least in part on first sensor metadata;
route the sensor data to a first database and the improved sensor data to a second database;
receive second sensor metadata during a second time period;
retrieve the sensor data from the first database;
generate updated improved sensor data, wherein generating the updated improved sensor data comprises processing the sensor data in a second sensor data processing unit based at least in part on the second sensor metadata; and
route the updated improved sensor data to the second database.

12. The apparatus of claim 11, wherein the improved sensor data is routed to a first container in the second database.

13. The apparatus of claim 12, wherein the updated improved sensor data is routed to a second container in the second database.

14. The apparatus of claim 13, wherein the at least one processor is configured to:
generate an ingestion specification, wherein the ingestion specification is configured to instruct the second database to overwrite at least a portion of the improved sensor data in the first container with at least a portion of the updated improved sensor data in the second container; and
transmit the ingestion specification to the second database.

15. The apparatus of claim 11, wherein the first sensor data processing unit comprises at least one of first ontology circuitry, first normalization circuitry, or first interpolation circuitry and the second sensor data processing unit comprises at least one of second ontology circuitry, second normalization circuitry, or second interpolation circuitry.

16. The apparatus of claim 15, wherein the first ontology circuitry is configured to associate the first sensor metadata with the sensor data.

17. The apparatus of claim 15, wherein the second ontology circuitry is configured to associate the second sensor metadata with the sensor data.

18. The apparatus of claim 11, wherein the second database is a time series database.

19. The apparatus of claim 11, wherein the at least one processor is configured to:
receive second sensor data from the sensor during the second time period; and
generate second improved sensor data, wherein generating the second improved sensor data comprises processing the second sensor data in the first sensor data processing unit based at least in part on the second sensor metadata.

20. A non-transitory computer-readable storage medium comprising computer program code for execution by one or more processors of a device, the computer program code configured to, when executed by the one or more processors, cause the device to:
receive sensor data from a sensor during a first time period;
generate improved sensor data, wherein generating the improved sensor data comprises processing the sensor data in a first sensor data processing unit based at least in part on first sensor metadata;
route the sensor data to a first database and the improved sensor data to a second database;
receive second sensor metadata during a second time period;
retrieve the sensor data from the first database;
generate updated improved sensor data, wherein generating the updated improved sensor data comprises processing the sensor data in a second sensor data processing unit based at least in part on the second sensor metadata; and
route the updated improved sensor data to the second database.
